(19) United States
(12) Patent Application Publication
(10) Pub. No.: US 2004/0155639 A1
(43) Pub. Date: Aug. 12, 2004

(54) Current mode controlled switched mode power supply

(76) Inventor: Antonius Maria Gerardus Mobers, Nijmegen (NL)

Correspondence Address: Philips Electronics North America Corporation, Intellectual Property & Standards, M/S41-SJ, 1109 McKay Drive, San Jose, CA, 95131, US

(21) Appl. No.: 10/481,999

(22) PCT Filed: Jun. 20, 2002
(86) PCT No.: PCT/IB02/02530

(30) Foreign Application Priority Data
Jun. 29, 2001 (EP) 01202515.1

(51) Int. Cl. G05F 1/40

(52) U.S. Cl. 323/282

(57) ABSTRACT

The invention concerns switched mode power supplies, and a current mode control circuit for such a power supply. In one of the described embodiments of the present invention, instead of employing a sense resistor directly in the primary circuit, line voltage and primary current are emulated by means of an auxiliary winding (130) on the primary side. Current flowing in a resistor (R₁) is buffered by means of first and second current mirrors (312, 313) to provide a voltage varying over time at an input of a pulse width modulator (322). This voltage is utilized to provide current mode controlled operation of the switch mode power supply.

The invention relates to a switched mode power supply incorporating a current mode control functionality, to over current protection circuits for switched mode power supplies and to primary short circuit protection circuits.

In many known flyback converters (which are a type of switched mode power supply) primary current is directly utilized for current mode control operation and for over current protection. Direct sensing of the primary current takes place over a sensing resistor, with the protection level being arranged to be as close as possible to the saturation current of the relatively expensive transformer. Because the sense resistor is in the main primary current path, it is important to keep power dissipation within the resistor low. For this reason, the resistor value is maintained as low as possible and this, in turn, means that the voltage sensed across that resistor is also low. Sensing such a low voltage in a high power environment means that this sensed voltage is very sensitive to noise. This can also lead to problems with current mode control. Signals from parasitic capacitances, inductances etc. can disturb the sensed signal and sophisticated compensation is often required to provide proper and reliable operation. A detailed description of some of the problems of known current sensing converters will be given to help clarify the technical problems addressed by the present invention.

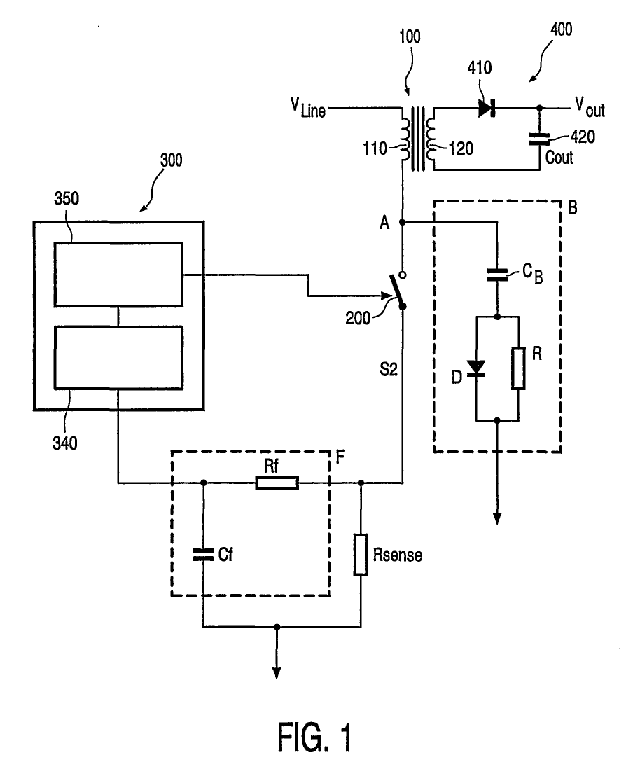

FIG. 1 shows part of a typical set up for a flyback converter using primary current sensing. In FIG. 1, there is shown a transformer 100, a power switch 200 (also referred to as S2), a switched mode power supply circuit 300, a sense resistor R_{Sense}, a secondary side output circuit 400, a circuit block B and a filter block F. The transformer 100 comprises a primary winding 110 and a secondary winding 120. The primary winding 110 receives an input voltage V_{Line} on one side and is further connected to a first terminal of the power switch S2 200. The secondary winding 120 of the transformer 100 is connected to the secondary side output circuit 400, which comprises a rectifying diode 410 and a stabilizing capacitor Cₒᵤₜ 420 to provide a rectified stabilized output voltage Vₒᵤₜ.

Power switch S2 200, as mentioned above, has a first terminal connected to the primary winding 110. It has a second terminal connected to a first terminal of R_{Sense} and a control input which receives a switching control signal from the switched mode power supply circuit 300. A second terminal of R_{Sense} is connected to ground.

Circuit block B is connected between the first terminal of S2 and ground and comprises a capacitor C_{B}, diode D and resistor R as shown.

The filter block F comprises a capacitor C_{F} and a resistor R_{F} in series. C_{F} and R_{F} are connected across R_{Sense} and at their mid-point a “sense” connection to the switched mode power supply circuit 300 is made.

The switched mode power supply circuit comprises a switch controller 350 for controlling S2 and a circuit 340 for providing current controlled operation via Rₛₑₙₛₑ and ancillary functions such as leading edge blanking and over current protection.

The operation of the circuit of FIG. 1 will now be described. The primary current is sensed over R_{Sense}, with the leading edge blanking/over current protection (LEB/OCP) block comparing the voltage across R_{Sense} to both a control level [hereinafter referred to as v_{Control}] and an over current level [hereinafter referred to as v_{Protection}]; V_{protection} is necessarily greater than v_{control}. For simplicity, it will be assumed that the converter of FIG. 1 operates as a fixed frequency converter, however the principles described apply equally to other power supply converter topologies.

In practice, S2 is often (but not limited to) a power MOSFET with the first terminal being a source terminal, second terminal being a drain and the control input a gate.

In a fixed frequency converter, a primary stroke is started (i.e. S2 turned on) at regular time intervals, and the secondary stroke starts (i.e. S2 turned off) when v_{Sense} first becomes equal to v_{Control}. Altering the timing of the start of the secondary stroke by varying v_{Control} allows the power output of the converter to be controlled.

The circuit block B, in particular capacitor C_{B}, limits dv_{drain}/dt as S2 switches. This is necessary to reduce electromagnetic interference (EMI) from switching transients that may be harmful to other nearby circuitry. Unfortunately, parasitic inductances form with the same C_{B} a resonant circuit, which causes a damped oscillatory current to flow in Rₛₑₙₛₑ at the commencement of the primary stroke. The oscillations in vₛₑₙₛₑ are superimposed on the desired ramp, and peaks in the oscillations may cause the premature commencement of the secondary stroke if vₛₑₙₛₑ exceeds v_{control} before the expected time. In addition, it is possible that the initial peak of the vₛₑₙₛₑ oscillation may exceed v_{Protection} as well as v_{Control}. To avoid premature switch off problems in the timing of the commencement of the secondary stroke, the LEB/OCP block 360 carries out leading edge blanking, LEB. LEB causes the signal on Rₛₑₙₛₑ to be ignored for a fraction of the switching frequency after commencement of the primary stroke. The use of LEB has the disadvantage that no load and low power operation are hindered, since the LEB time (“on” time of S2) determines the minimum power level.

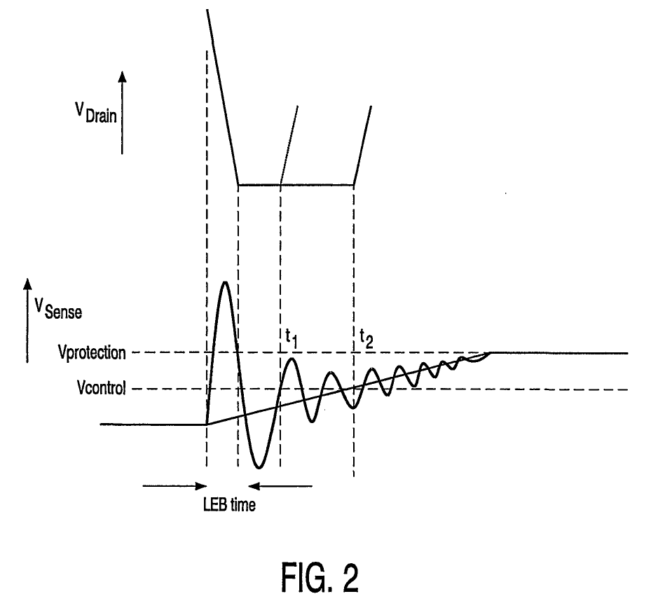

The lower trace shown in FIG. 2 illustrates how the voltage Vₛₑₙₛₑ varies over time in relation to V_{Drain} (the upper trace of FIG. 2). The steady ramp voltage of the lower trace represents the idealized case, whereas the ringing shows what actually occurs at Vₛₑₙₛₑ under the oscillatory conditions described above. Here it can be seen that the initial oscillation clearly rises above V_{protection} (and in the absence of LEB would cause premature switch off). At a time point shown as t₁, the oscillations can be above V_{control} which would cause premature termination (indicated by the broken line of the upper trace) of the primary stroke under current controlled mode. Such oscillations after the LEB interval, cause premature commencement of the secondary stroke as vₛₑₙₛₑ approaches v_{control}. To reduce this problem of jitter, the filter F comprising resistor R_{f} and capacitor C_{f} is employed to ensure the oscillations are sufficiently damped as vₛₑₙₛₑ approaches V_{control} and have the aim of enabling termination of the primary/commencement of the secondary at the correct time point t₂.

Even if C_{B} were not present, parasitic capacitances in the primary, secondary or elsewhere can cause the same problems.

It is an aim of the present invention to provide an improved switched mode power supply. To this end, the invention provides a current mode controlled switched mode power supply as defined by the independent claims. The dependent claims define advantageous embodiments. It is an aim of preferred embodiments of the present invention to provide a switched mode power supply incorporating stable and simplified current mode control functionality.

In one of the described embodiments of the present invention, instead of employing a sense resistor directly in the primary circuit, line voltage and primary current are emulated by means of an auxiliary winding on the primary side. Current flowing in a resistor is buffered by means of first and second current mirrors to provide a voltage varying over time at an input of a pulse width modulator. This voltage is utilized to provide current mode controlled operation of the switch mode power supply.

The isolation provided for by the present invention yields the benefits of avoiding the jitter and leading edge blanking problems associated with the prior art. The input current is also indicative of the line voltage. The input current is preferably provided by an auxiliary winding of a switched mode power supply. The pulse width modulator may comprise a comparator.

Preferably, the voltage varying over time increases over time. Preferably, the voltage varying over time comprises a ramp voltage. This voltage emulates the form of the primary current.

The switched mode power supply may also comprise over current protection. The over current protection may comprise a protection voltage input to a comparator, the comparator being arranged to provide an output signifying the presence of an over current condition to the switch controller if the voltage varying over time exceeds the protection voltage. Upon detection of such an over current condition, the switch controller is preferably arranged to discontinue flow of the primary current in the switched mode power supply.

The switched mode power supply may still further comprise a primary short circuit protection circuit. The primary short circuit protection circuit may comprise a buffer means for buffering a reference current, a delay circuit and a set/startup latch which may be set in response to the absence of the input current, the setting of set/startup latch by the delay circuit signifying the presence of a primary short circuit condition to the switch controller. Preferably, the buffer means comprises a third current mirror. The third current mirror is preferably arranged to provide a buffered reference current. Preferably, the delay circuit may comprise a filter or any other suitable circuitry.

For a better understanding of the invention, and to show how embodiments of the same may be carried into effect, reference will now be made, by way of example, to the accompanying diagrammatic drawings in which:

FIG. 1 illustrates an example of a prior art switched mode power supply;

FIG. 2 illustrates how oscillations in vₛₑₙₛₑ can cause jitter in the timing of the commencement of the secondary stroke;

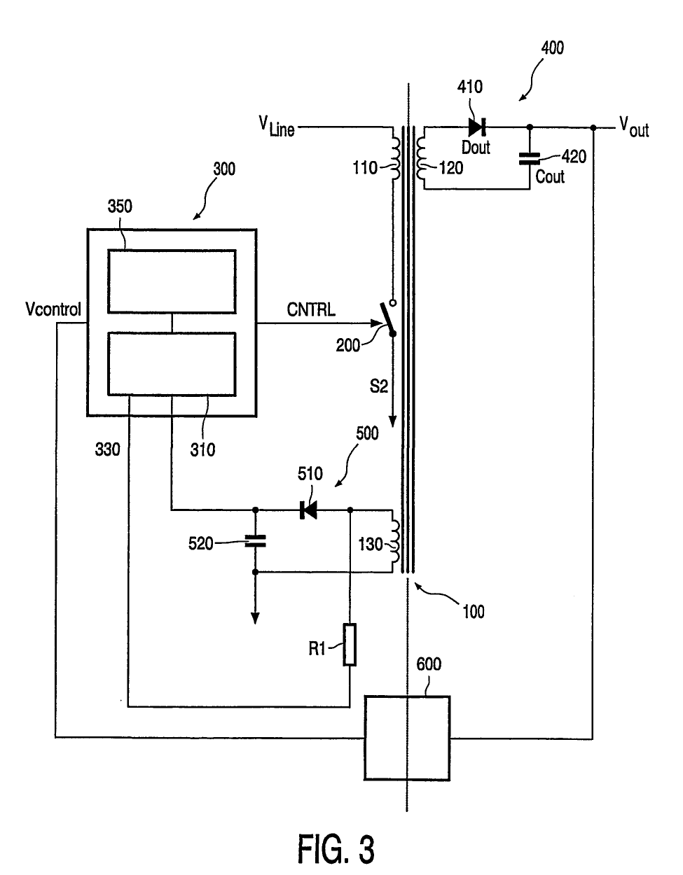

FIG. 3 illustrates in schematic form a switched mode power supply in accordance with an embodiment of the invention;

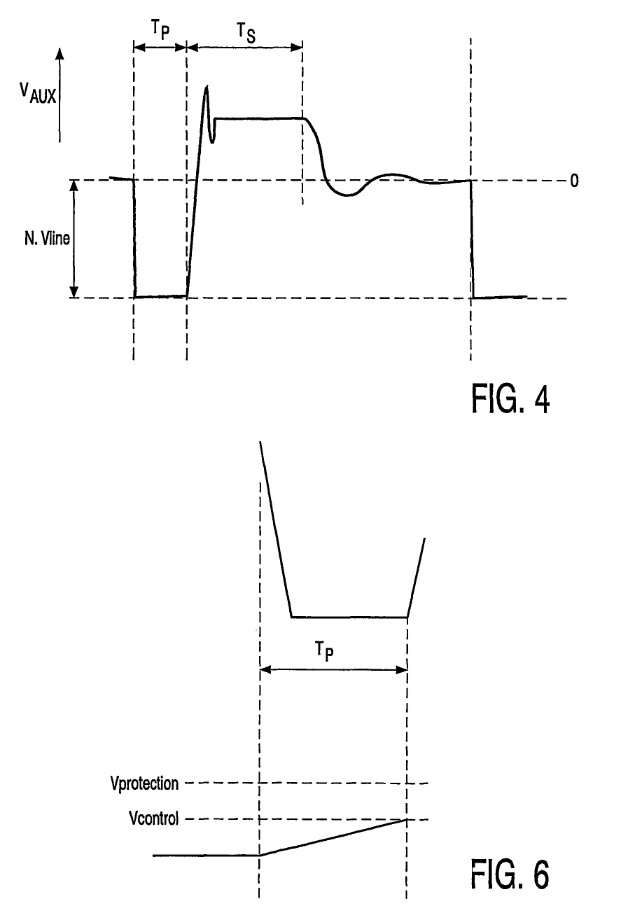

FIG. 4 illustrates the variations of V_{AUX} with time over a switching cycle;

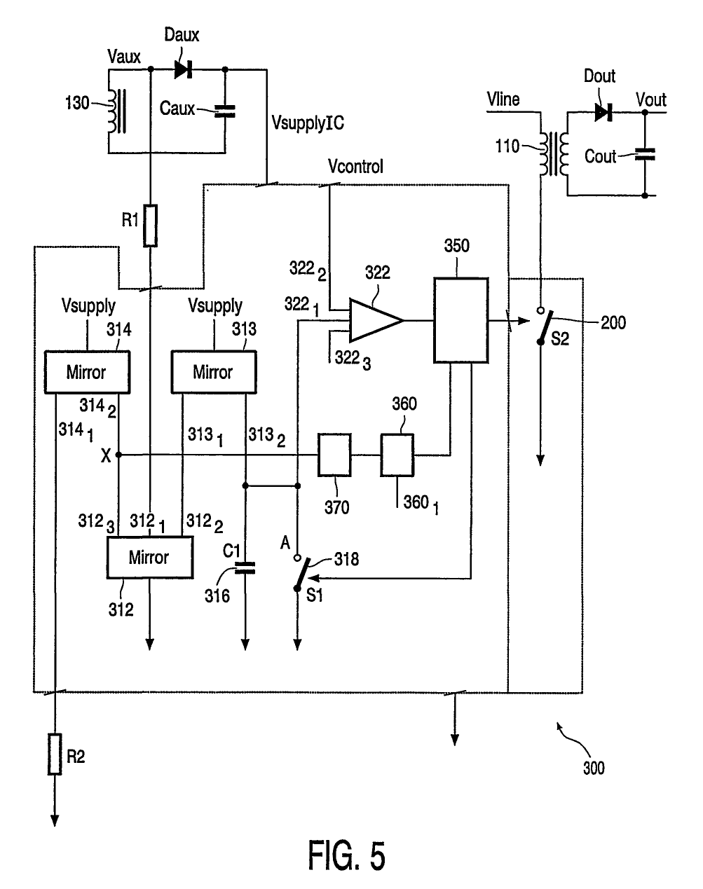

FIG. 5 illustrates detail of control and protection circuitry of the switched mode power supply of FIG. 3, and;

FIG. 6 illustrates a voltage varying over time which, in accordance with embodiments of the present invention, is utilized to provide the current controlled operation of an SMPS.

Referring to FIG. 3, there is shown in schematic form a switched mode power supply comprising a transformer 100, a power switch 200, a switched mode power supply circuit 300, secondary side output circuit 400 an auxiliary output circuit 500, a Vₒᵤₜ control means 600 for providing a control signal V_{control} which is dependant upon, but isolated from, the secondary side output voltage Vₒᵤₜ.

The transformer 100 has a primary winding 110, a secondary winding 120 and an auxiliary winding 130. The secondary winding 120 is connected to the secondary side output circuit 400 which comprises rectifying means 410 and a voltage stabilizing means 420, shown here respectively as a diode Dₒᵤₜ and capacitor Cₒᵤₜ.

The primary winding 110 receives an input voltage V_{LINE} which is switched by the power switch 200 under the control of a control output CNTRL of the switched mode power supply controller 300. Typically, the power switch 200 is a power MOSFET.

The auxiliary winding 130 of the transformer 100 is a power and sense winding which delivers a rectified voltage by means of the auxiliary output circuit 500. The auxiliary output circuit 500 comprises auxiliary voltage rectifier 510 and auxiliary voltage stabilizer 520 that comprise, respectively, a diode Dₐᵤₓ and a capacitor Cₐᵤₓ. Resistor R₁ is a sense resistor for sensing the auxiliary voltage and has a first end connected to the auxiliary winding 130 and a second end connected to a terminal 330 of the switched mode power supply 300.

The switched mode power supply IC 300 comprises a switch controller 350 and a current mode control and current protection circuit 310.

Vₒᵤₜ control means 600 regulates the secondary side output voltage and also generates control voltage V_{control} for use within the switched mode power supply. The Vₒᵤₜ control means 600 isolates the primary side from the secondary side functions, for instance, by means of an opto-coupler.

Variation of V_{AUX} over time is shown in FIG. 4. Here, the primary stroke is designated by time period T_{P} and the secondary stroke by period T_{S}.

Referring to FIG. 5, the current mode control current and protection circuit 310 comprises input current buffer means composed of first and second current mirrors 312, 313, voltage control means comprising a capacitor 316 (also referred to hereinafter as C1), a switch 318 (also referred to as S1) and a comparator 322.

There is also provided a primary short circuit protection circuit comprising a buffer in the form of a third current mirror 314, a delay element 370 and a reset/startup latch 360. Resistances R1 and R2 shown are, typically, discrete components. The transformer and related elements correspond to those elements already described in relation to FIG. 3.

In FIG. 5, Vₒᵤₜ control means 600 has been omitted for the sake of clarity. However, the control signal V_{control} and its connection to the current mode control and protection circuit 310 is shown.

The detailed construction of the circuit of FIG. 5 will now be described. As already noted, resistor R1 has a first terminal connected to the auxiliary winding 130. The second end of R1 is connected to a first input 312₁ of first current mirror 312. The current mirror 312 provides a mirror current output at terminal 3122. For accuracy reasons the voltage at 312₁ must be near to ground level. In this way, the current flowing in resistor R1 (hereinafter referred to as I_{R1}) is reflected once by the current mirror 312. This reflected current is input to a first input terminal 313₁ of the second current mirror 313. In turn, this current is reflected once more in the output of the second current mirror at 313₂. The current at output 313₂ is, it will be understood a current having the same polarity as the current IRI flowing through resistor R1. The pair of current mirrors 312, 314 thereby provides a buffered current with voltage and current correction. The current I_{R1} emulates the line voltage Vₗᵢₙₑ.

The following equation holds:

$${I}_{R1} = \frac{{V}_{aux} - {V}_{{312}_{1}}}{R1} \approx \frac{{V}_{aux}}{R1} = \frac{N \cdot {V}_{LINE}}{R1} ,$$

where N is the turns ratio between the primary winding and the auxiliary winding.

The output 313₂ of the second current mirror 313 is connected to a first end of capacitor C1 316, the other end of capacitor C1 316 being connected to ground. The first end of capacitor C1 is also connected to a switched terminal of switch S1 318. Switch S1 is a make or break switch which selectively switches the first end of capacitor C1 316 to ground in accordance with a control output of switch controller 350. The voltage V_{c1} at switch S1 varies in accordance with:

$$\frac{ⅆ {V}_{C1}}{ⅆ t} = \frac{{I}_{R1}}{C1} = \frac{N \cdot {V}_{Line}}{C1} = {K}_{1} \cdot {V}_{Line}$$

$${K}_{1} = \frac{N}{C1}$$

which is constant for a certain application.

If we compare this to a case using a sense resistor as in the prior art then:

$$\begin{matrix}{K}_{2} = \frac{{R}_{Sense}}{{L}_{p}} which is constant for all applications . \\ \frac{ⅆ {V}_{Sense}}{ⅆ t} = \frac{ⅆ \cdot {I}_{Sense} \cdot {R}_{Sense}}{ⅆ t} = \frac{{V}_{Line} \cdot {R}_{Sense}}{{L}_{p}} = {K}_{2} \cdot {V}_{Line}\end{matrix}$$

It can therefore be seen that the voltage V_{c1} is a ramp voltage varying over time, which emulates the idealized V_{Sense} voltage of the prior art representing the varying primary current over time. This is illustrated in FIG. 6.

The first end of capacitor C1 316 is also connected to a first input 322₁ of the comparator 322, which has a second input 322₂ for receiving a control voltage V_{control} and a third input 322₃ for receiving an output over voltage level signifying signal V_{potection} (which may be generated either internally or externally to the circuit 310). The comparator 322 provides a signal to switch controller 350 output for selectively causing the power switch 200 to open and S1 to close. It will be understood that whilst element 322 is shown as and referred to as a single comparator, it may represent a number of comparators.

First current mirror 312 also provides a second mirrored current 312₃ which is connected to an output 314₂ of third current mirror 314 and to delay element 370. A current input 314₁, of third current mirror 314 passes through a resistance R2 and represents a minimum permissible V_{Line} level. The output of delay element 370 is fed to set/startup latch 360. Set/startup latch 360 also receives a reset signal 360₁ at startup, and is connected to switch controller 350.

Operation of the circuit of FIGS. 3 and 5 will now be described. In accordance with the general principles of switched mode power supplies, the switching is applied to a power switch for selectively allowing or inhibiting primary current flow. According to application, this switching is carried out at a given frequency, and with given time periods for the primary and secondary strokes. The period during which power is flowing is referred to as the primary stroke. In fixed frequency fly back converters, this primary stroke starts after a particular elapsed period of time. In other types of switched mode power supplies, such as self-oscillating power supplies, the primary stroke starts on the basis of a sensed voltage.

In general, the switch controller 350 of the switched mode power supply 300 switches the power switch 200 and S1 as desired. When the power switch 200 is closed, it will be appreciated that voltage vₐᵤₓ is generated in the auxiliary winding 130. Generation of voltage vₐᵤₓ causes an emulation current IRI to flow through resistor R1 and to charge, via current mirrors 312, 313 the capacitor 316. At this point in time, while capacitor 316 is charging, switch S1 is open. Indeed, the switch controller 350 is arranged to control switching of switch S1 according to internal information gathered by the switched mode power supply 300. In particular, the drive to the control input of switch S1 318 is the inverse of the drive supplied to switch S2 by the switching part 350. By this we mean, that under normal operation, when S2 is closed, S1 is open and when S2 opens, S1 is closed.

From the above description, it will be appreciated that the emulation current I_{R1} charges capacitor C1 316 so that its first terminal charges from zero volts, to approach V_{control}. There is therefore a ramping voltage on the first input 322₁ of comparator 322 that functions as a pulse width modulator. The capacitor C1 316 is responsive to the input current to provide a voltage varying over time to the comparator/pulse width modulator 322. Pulse width modulator 322 has a second input 3222 that is attached to control voltage V_{Control}. In this manner, should the voltage v_{c1} appearing at the first terminal of capacitor C1 316 rise above V_{control}, then the comparator 322 is arranged to change from a first state to a second state, thereby providing a signal to switch controller 350. In response to such a signal switch controller operates S1 and S2 to discharge C1 and start the secondary stroke.

The switch controller 350 in combination with the switch S1 provide reset means for resetting the voltage developed across C1 to zero at the end of the primary stroke.

From the above description, and considering the voltage trace of FIG. 6 (which shows the potential at node A of FIG. 5 in analogous fashion to the trace of FIG. 3), it will be appreciated that by appropriate setting of v_{control}, the commencement of the secondary stroke caused by operation of the switch 200 is controllable and that this means that the SMPS has current mode control. It will also be appreciated that if primary current for any reason goes above a desired value (in particular approaching the saturation level of the transformer) then when the voltage first reaches the protection voltage v_{protection}, the power supply detects a primary over current and leaves the normal current flowing operation.

The operation of the primary short circuit protection circuitry will now be described.

During normal operation the input current is larger than the reference current and node X (the junction between current mirror outputs 312₃, 314₂ and the input to delay 370) is low indicating an inactive set signal.

In the event of a primary short circuit, no voltage will be induced on the auxiliary winding, and consequently no input current to the control circuitry will be produced. The mirrored current 3123 will also be absent. However, current will be flowing in such conditions from output 3142 of third current mirror 314. Because during a primary short the input current is lower than the reference current (i.e. the reflected Vₗᵢₙₑ level is lower than a reference level defined by R2), node X becomes high, such that an active signal is sent via the delay circuit 370 to the latch 360. The set/startup latch 360 indicates to the switch controller 350 that a primary short circuit has occurred and normal operation of the SMPS ceases. Disconnection of the line voltage and a subsequent power-on reset signal is needed to input 360₁ of set/startup latch before allowing the switch controller 350 to resume normal operation.

The dashed boxes of FIG. 5 indicate portions of a switched mode power supply controller 300 that may be integrated in a single package. It will also be appreciated that the control and protection circuits could be provided on one chip/package, whilst a switching part 200 may be provided on another chip/package.

Resistor R1 is a discrete component which may be chosen in accordance with a turns ratio linking the primary winding 110 with the auxiliary winding 130. In this way, differing turns ratios can be accommodated, whilst a desired protection level may be set by a circuit designer or an end user as is appropriate.

In embodiments of the present invention, it will be appreciated that the voltage V_{c1} has the same characteristic shape as the primary current and emulates this current, but the voltage V_{c1} is not susceptible to disturbances in the same way as the sensing voltage over a conventional sense resistor. Further, a lack of disturbances to the voltage V_{c1} avoids a potential source of jitter in the timing of the commencement of the secondary stroke. Moreover, operating signals are larger and not susceptible to noise. By using the teachings of the present invention to provide primary current protection, removal of the sense resistor is possible and the consequent dissipations in that sense resistor are avoided. For instance, for a 150-watt full range converter, such dissipations could be as high as 1 Watt at low line operation. Another advantage is that the power current path is smaller—limiting noise. Other circuitry such as the filter F of FIG. 1 that would be used to damp oscillations in a sensed voltage, or safety measure such as diodes placed in parallel to a sensing resistor can also be omitted. Another advantage for SMPS controllers incorporated into integrated circuit packages is that the sense voltage requires an additional connection to external components. The present invention may enable the number of integrated circuit pins to be reduced, therefore reducing cost.

To summarize, in arrangements of the present invention, as a result of the primary current being emulated, the real primary current is not measured. In the case of a short circuit of the primary winding, no voltage appears in the auxiliary winding and, thus, the operation of the power supply is terminated immediately and can only be reactivated after a line voltage disconnection has taken place.

Further advantages of embodiments of the invention are that certain external elements such as the filter F of FIG. 1 can be avoided and that the same connection pin of the package that is used for connection to R1 for current mode controlled operation is utilized for other functions such as the over current/over voltage/primary short circuit protection etc. Whilst not discussed herein, this same pin may also be utilized for demagnetization protection and/or output over voltage protection.

It will be appreciated by the man skilled in the art that numerous variations may be made which are still within the scope of the present invention. The transformer may have either more or less windings than shown. For instance, the auxiliary winding may be omitted and replaced by a further (buffered) connection from the primary winding 110. In another variation, the first and second current mirrors could be omitted and R1 coupled directly to C1. In practice however, buffers preferably in the form of mirrors are provided for accuracy and buffering reasons. R2 may be a discrete component or may be provided integrated onto the chip/provided in the package. In other variations R2 may be replaced by an internal current source function. The scope of the present invention is thus limited only by the accompanying claims. In the claims, any reference signs placed between parentheses shall not be construed as limiting the claim. The word “comprising” does not exclude the presence of elements or steps other than those listed in a claim. The word “a” or “an” preceding an element does not exclude the presence of a plurality of such elements. The invention can be implemented by means of hardware comprising several distinct elements, and by means of a suitably programmed computer. In the device claim enumerating several means, several of these means can be embodied by one and the same item of hardware. The mere fact that certain measures are recited in mutually different dependent claims does not indicate that a combination of these measures cannot be used to advantage.

1. A current mode control circuit for a switched mode power supply, the circuit comprising:
means for providing a voltage varying over time in response to an input current, said means being arranged to be periodically reset; and
a pulse width modulator having a first input connected to an output of the means for providing a voltage varying over time, and a second input connected to a control voltage, for providing an output signal to a switch controller to discontinue flow of a primary current in the switched mode power supply when the voltage varying over time reaches the control voltage, wherein the voltage varying over time is indicative of, but isolated from the primary current.

2. A circuit according to claim 1, wherein the input current is provided by an auxiliary winding of a transformer of the switched mode power supply.

3. A circuit according to claim 1, wherein the voltage varying over time increases over time.

4. A circuit according to claim 3, wherein the voltage varying over time comprises a ramp voltage.

5. A circuit according to claim 1, wherein input current buffer means are provided for buffering the input current prior to processing by the means for providing a voltage varying over time.

6. A circuit according to claim 5, wherein the input current buffer means comprise current mirroring means for receiving the input current and providing a buffered current to the means for providing a voltage varying over time.

7. A circuit according to claim 6, wherein the current mirroring means comprise first and second current mirrors, the first current mirror being arranged to receive the input current and provide a first mirrored output, the second current mirror being arranged to receive the first mirrored output and provide a second current mirrored output forming the buffered current to the means for providing a voltage varying over time.

8. A circuit according to claim 7, wherein the means for providing a voltage varying over time comprise a capacitor and a reset means, the capacitor being is charged by the buffered input current during periods in which the reset means is inactive.

9. A circuit according to claim 8, wherein the reset means comprise a controlled switch arranged in parallel across the capacitor, the controlled switch being arranged to be active in a closed position in which the capacitor is shorted out and to be inactive in an open position so as to allow the capacitor to charge in accordance with the buffered input current.

10. A circuit according to claim 9, wherein the controlled switch is selectively opened or closed in accordance with a desired frequency of a switched mode power supply, the switch being opened at the start of a primary stroke of the switched mode power supply and being closed at the end of a primary stroke of the switched mode power supply.

11. A circuit according to claim 10, wherein the switch controller is arranged to control a power switch of a primary circuit of a switched mode power supply to connect or disconnect a primary winding of a transformer of the switched mode power supply.

12. A circuit according to claim 11, wherein in a normal operation cycle of the switched mode power supply, the control voltage at the second input of the pulse width modulator is arranged to dictate the timing of the discontinuation of the flow of the primary current.

13. A circuit according to claim 11, wherein the controlled switch and the power switch open and close in opposition.

14. The circuit of claim 1, further comprising over current protection, wherein a protection voltage input is to a comparator, the comparator being arranged to provide an output signifying the presence of an over current condition to the switch controller if an input voltage of the comparator exceeds the protection voltage, the switch controller being arranged to discontinue flow of the primary current in the switched mode power supply.

15. The circuit of claim 1, further comprising a primary short circuit protection circuit comprising a buffer means for buffering a reference current, a delay circuit and a set/startup latch which may be set in response to the reference current, the setting of set/startup latch by the delay circuit signifying the presence of a primary short circuit condition to the switch controller.

16. The circuit of claim 15, wherein the buffer means comprises a third current mirror being arranged to provide a buffered reference current for providing a primary short winding detection.

17. A switched mode power supply comprising the circuit of claim 1.
